(19) United States
(12) Patent Application Publication
(10) Pub. No.: US 2016/0359992 A1
(43) Pub. Date: Dec. 8, 2016

(54) DEVICE, SYSTEM AND METHOD FOR WEARABLE COMPUTING

(71) Applicant: KIWI WEARABLE TECHNOLOGIES LTD., Toronto (CA)

(72) Inventors: Ali NAWAB, Richmond Hill (CA); John David CHIBUK, Ottawa (CA); Olivier MAYRAND, Toronto (CA)

(21) Appl. No.: 14/989,637

(22) Filed: Jan. 6, 2016

Related U.S. Application Data
(60) Provisional application No. 62/100,151, filed on Jan. 6, 2015.

(51) Int. Cl. H04L 29/08

(52) U.S. Cl. CPC H04L 67/22; H04L 67/18

(57) ABSTRACT

A computer implemented method is provided, the method being performed by a processor, the processor in communication with a server computer over a communication network, the method comprising: a) receiving input from a plurality of sensors and b) performing a motion tracking task based on a user profile.

### CROSS REFERENCE TO RELATED APPLICATIONS

This application claims priority from U.S. provisional patent application No. 62/100,151, filed Jan. 6, 2015, the entire contents of which are incorporated herein by reference.

### FIELD OF THE INVENTION

The present invention relates generally to wearable computing devices. The present invention further relates to device, methods and systems for developing, managing and operating wearable computing products.

### BACKGROUND OF THE INVENTION

Modern lifestyles benefit from the convenience of numerous communication tools such as mobile phones. computers, laptops, collaboration platforms, social media platforms and software, news feed and so on. Wearable computing devices such as Google Glass™ are gaining support and attention in the world of consumer electronics.

Kiwi Wearable Technologies is in the business of developing and commercializing wearable computer and sensor technology with an open platform for innovation and application development. Kiwi technology, or simply Kiwi, may refer to the wearable computing device itself or the overall computing system and platform on which the device operates.

### SUMMARY OF THE INVENTION

In accordance with an aspect of the present invention there is provided a method, the method being performed by a processor, the processor in communication with a server computer over a communication network, the method comprising: a) receiving input from a plurality of sensors and b) performing a motion tracking task based on a user profile.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1a illustrates in a top perspective view a multi sensor multi functional wearable computer, in a first embodiment thereof;

FIG. 1b illustrates in a bottom perspective view the multi sensor multi functional wearable computer of the first embodiment thereof;

FIG. 1c illustrates in a right plan view of the multi sensor multi functional wearable computer of the first embodiment thereof;

FIG. 1d illustrates a front plan view of the multi sensor multi functional wearable computer of the first embodiment thereof;

FIG. 1e illustrates a left plan view of the multi sensor multi functional wearable computer of the first embodiment thereof;

FIG. 1f illustrates a back plan view of the multi sensor multi functional wearable computer of the first embodiment thereof;

FIG. 1g illustrates a top plan view of the multi sensor multi functional wearable computer of the first embodiment thereof;

FIG. 1h illustrates a bottom plan view of the multi sensor multi functional wearable computer of the first embodiment thereof;

FIG. 2a illustrates in a top perspective view a multi sensor multi functional wearable computer holder, in a second embodiment thereof;

FIG. 2b illustrates in a bottom perspective view the multi sensor multi functional wearable computer holder of the second embodiment thereof;

FIG. 2c illustrates in a right plan view of the multi sensor multi functional wearable computer holder of the second embodiment thereof;

FIG. 2d illustrates a front plan view of the multi sensor multi functional wearable computer holder of the second embodiment thereof;

FIG. 2e illustrates a left plan view of the multi sensor multi functional wearable computer holder of the second embodiment thereof;

FIG. 2f illustrates a back plan view of the multi sensor multi functional wearable computer holder of the second embodiment thereof;

FIG. 2g illustrates a top plan view of the multi sensor multi functional wearable computer holder of the second embodiment thereof;

FIG. 2h illustrates a bottom plan view of the multi sensor multi functional wearable computer holder of the second embodiment thereof;

FIG. 3a illustrates in a top perspective view a multi sensor multi functional wearable computer and holder, in a third embodiment thereof;

FIG. 3b illustrates in a bottom perspective view the multi sensor multi functional wearable computer and holder of the third embodiment thereof;

FIG. 3c illustrates in a right plan view of the multi sensor multi functional wearable computer and holder of the third embodiment thereof;

FIG. 3d illustrates a front plan view of the multi sensor multi functional wearable computer and holder of the third embodiment thereof;

FIG. 3e illustrates a left plan view of the multi sensor multi functional wearable computer and holder of the third embodiment thereof;

FIG. 3f illustrates a back plan view of the multi sensor multi functional wearable computer and holder of the third embodiment thereof;

FIG. 3g illustrates a top plan view of the multi sensor multi functional wearable computer and holder of the third embodiment thereof;

FIG. 3h illustrates a bottom plan view of the multi sensor multi functional wearable computer and holder of the third embodiment thereof;

FIG. 4 illustrates exemplary API applications for a wearable computing device in accordance with one aspect of the invention.

FIG. 5 demonstrates an exemplary conceptual architecture for a wearable computing device in accordance with one aspect of the invention.

FIG. 6 illustrates an exemplary system block diagram for a wearable computing device in accordance with one aspect of the invention.

FIG. 7 illustrates an exemplary high level technology architecture for a wearable computing device in accordance with one aspect of the invention.

FIG. 8 illustrates an exemplary hardware schematic for a wearable computing device in accordance with one aspect of the invention.

FIG. 9 illustrates an exemplary hardware schematic for a wearable computing device in accordance with another aspect of the invention.

FIG. 10 illustrates an exemplary hardware component for a wearable computing device in accordance with yet another aspect of the invention.

FIG. 11 illustrates an exemplary user interface for developers to analyze the sensor data in accordance with yet another aspect of the invention.

FIGS. 12a-12c each illustrates an exemplary mobile application for a wearable computing device in accordance with one aspect of the invention.

FIGS. 13a and 13b each illustrates an exemplary mobile application for a wearable computing device in accordance with another aspect of the invention.

FIG. 14 illustrates an exemplary circuit diagram for a wearable computing device in accordance with one aspect of the invention.

FIG. 15 illustrates another exemplary circuit diagram for a wearable computing device in accordance with another aspect of the invention.

FIG. 16 illustrates another exemplary circuit diagram for a wearable computing device in accordance with another aspect of the invention.

FIG. 17 illustrates another exemplary circuit diagram for a wearable computing device in accordance with another aspect of the invention.

FIG. 18 illustrates another exemplary circuit diagram for a wearable computing device in accordance with yet another aspect of the invention.

FIG. 19 illustrates another exemplary circuit diagram for a wearable computing device in accordance with yet another aspect of the invention.

FIG. 20 illustrates an exemplary representative implementation of the invention.

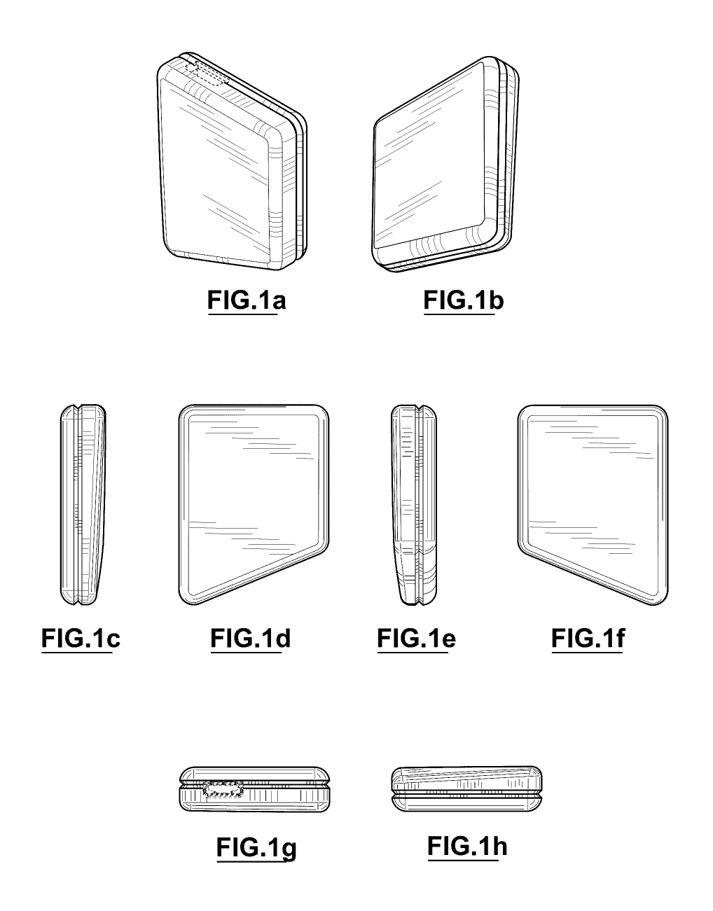

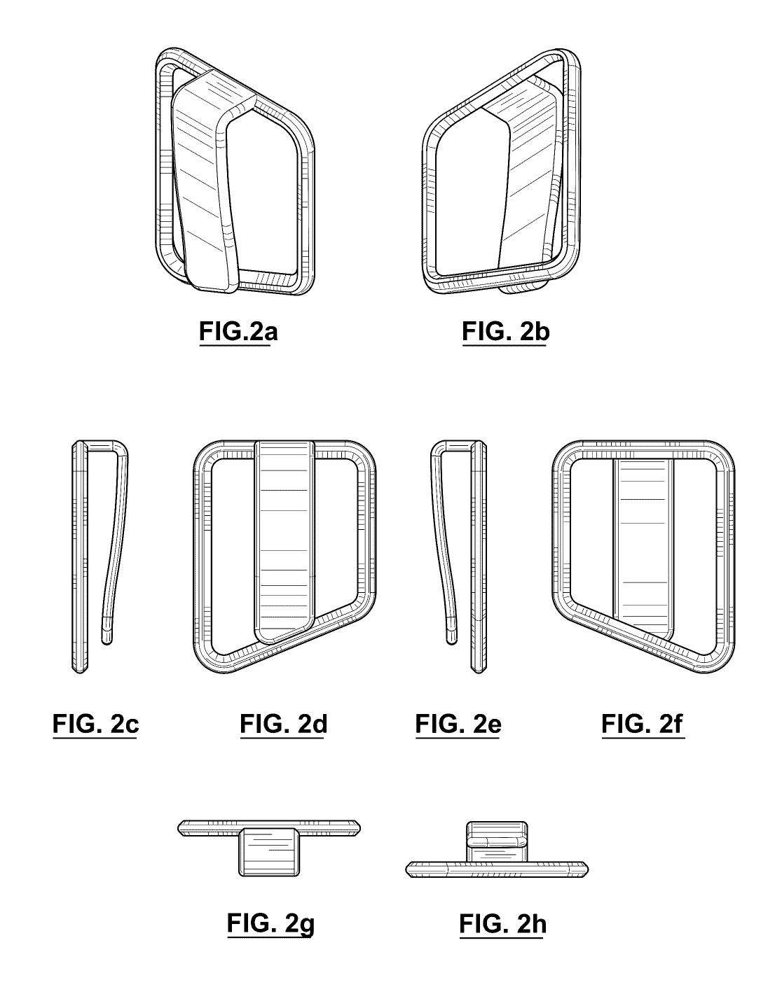

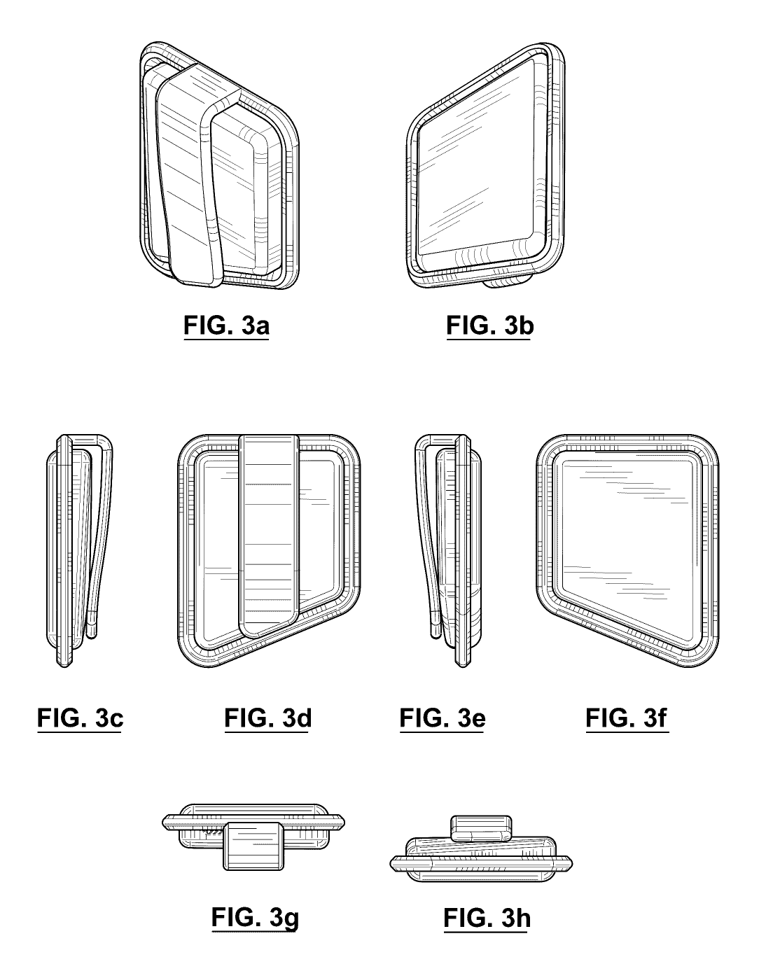

### DETAILED DESCRIPTION

In one exemplary embodiment of the invention, there is provided a device, a web-based sensor platform, a developer tool kit and six sample demo applications for a wearable computing device system.

In another embodiment of the invention, the technology focus may be on motion sensor data architecture, classification algorithms and developing user-centric tools and applications.

In yet another embodiment of the invention, a primary focus can be in machine learning, sensors in sports, heart rate variance classification and arrhythmia detection.

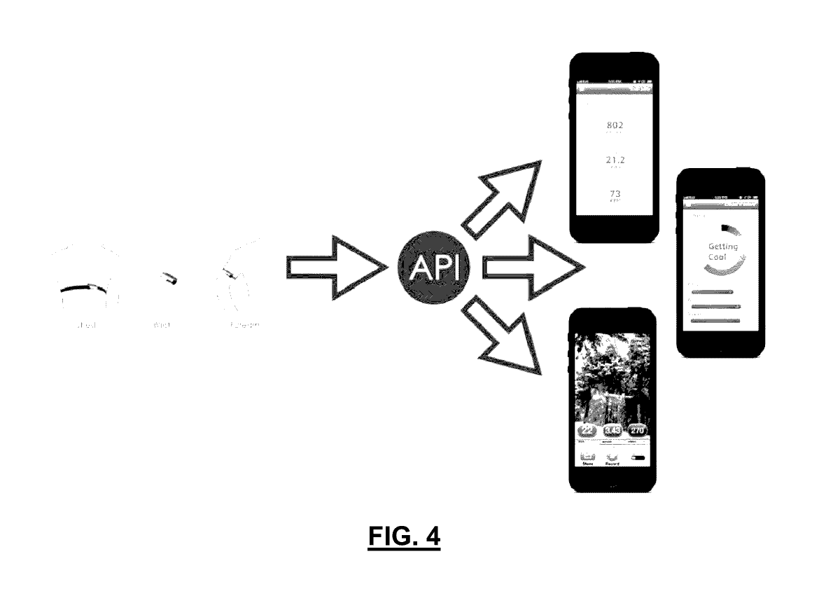

Referring now to FIG. 4, which illustrates exemplary API applications for a wearable computing device in accordance with one aspect of the invention. Kiwi technology can be a ubiquitous, multi-sensor, connected, wearable device with an open API for application development.

In one embodiment of the invention, a first wearable computing device product can be called Kiwi Move, and may be a 1″×2″ sized smart, connected, sensor system on a chip, and may be coupled to a wearable strap. The Kiwi Move device can be supported by the Kiwi cloud platform, a back-end component and associated API, that enables rapid and simplified development of a wide range of smart, innovative, user-centric wearable tech experiences and motion based applications. The back-end component (or the “back-end”) may be web-based, server-based or centralized.

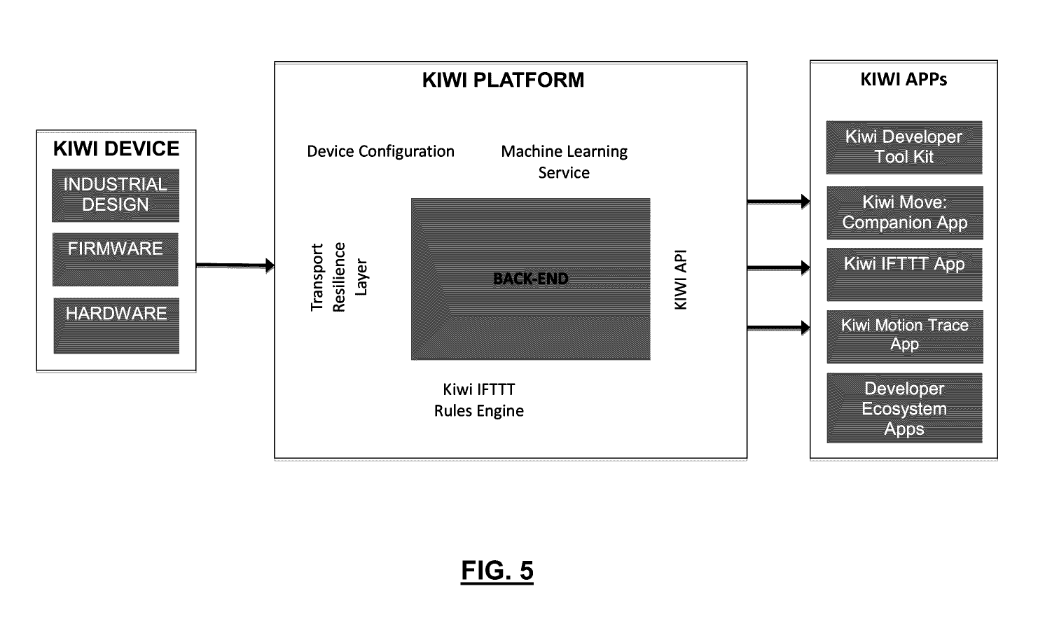

Referring now to FIG. 5, which demonstrates an exemplary conceptual architecture for a wearable computing device in accordance with one aspect of the invention. The table below summarizes the Kiwi technology in one embodiment of the invention:

| Component | Summary Description | Technology |
|---|---|---|
| Back-end | Receives and processes device | Server-side JavaScript |
| | information, sensor data stream and motion | Express; Node.js; Redis/ |
| | events, making this available in real-time | MongoDB; WebSocket server; |
| | for application development and algorithm | Evaluating real-time frameworks |
| | design. | (Sails.js) and high-performance, |
| | Integrates with workers: machine learning | high scale real-time database |
| | service, rules engine, device configuration | (Aerospike) |
| Front end, | Kiwi powered applications can be pre- | API: Socket-interface; Rest API; |
| mobile | dominantly cloud-connected, built using | Kiwi IFTTT Rules API; Kiwi |
| | the the Kiwi API. Front-end applications | OAuth; |
| | can be be built on any platform, including | Web: HTML5, Angular, |
| | platforms that supports HTTP and | Processing.js |
| | WebSockets. | Mobile: Native |
| Workers | The Kiwi Back-end can be supported by 4 | Primarily JavaScript and Node: |
| | workers, each with an API wrapper: | UDP, TCP, WebSocket, Redis |
| | Transport layer | Integration with MongoDB and |
| | Rules engine for event handling | 3^{rd} party services (eg. Twilio, |
| | Machine learning service | SendGrid) |
| | Device configuration | OpenCPU, Nginx, Node, R |
| | | Classifiers |
| Co-location | Servers can be monitored and managed | Heroku, Rackspace, AWS |
| | remotely by system administrators. | Chef Opscode for configuration |
| | | mgmt. |
| Firmware | There may be an embedded system that | Programming Language: C, |
| | integrates with the Kiwi back-end and API. | Assembly |
| | The software system can be designed to be | Real-time operating system: |
| | fully-programmable, built on a real-time | Unison |
| | operating system, with custom sensor | Custom application logic |
| | drivers and API abstraction. | Fully programmable device API |
| Hardware | The Kiwi Move can be custom engineered, | Sensors: Inertial Measurement |
| | multi sensor, network connected, 1“x2” | Unit, Microphone, Temperature, |
| | system on a chip, wearable computer in | Barometer |
| | casing and strap | Computing: 72 mhz, 64 MB flash |
| | | Connectivity: Wi-Fi, USB |

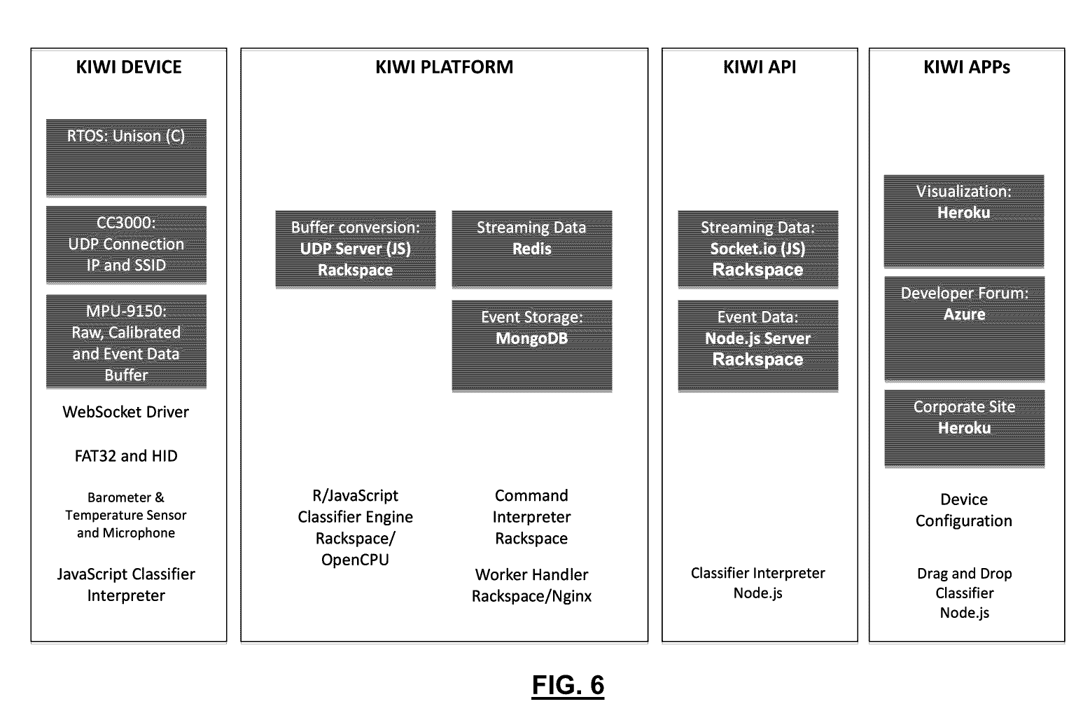

Referring now to FIG. 6, which illustrates an exemplary system block diagram for a wearable computing device in accordance with one aspect of the invention.

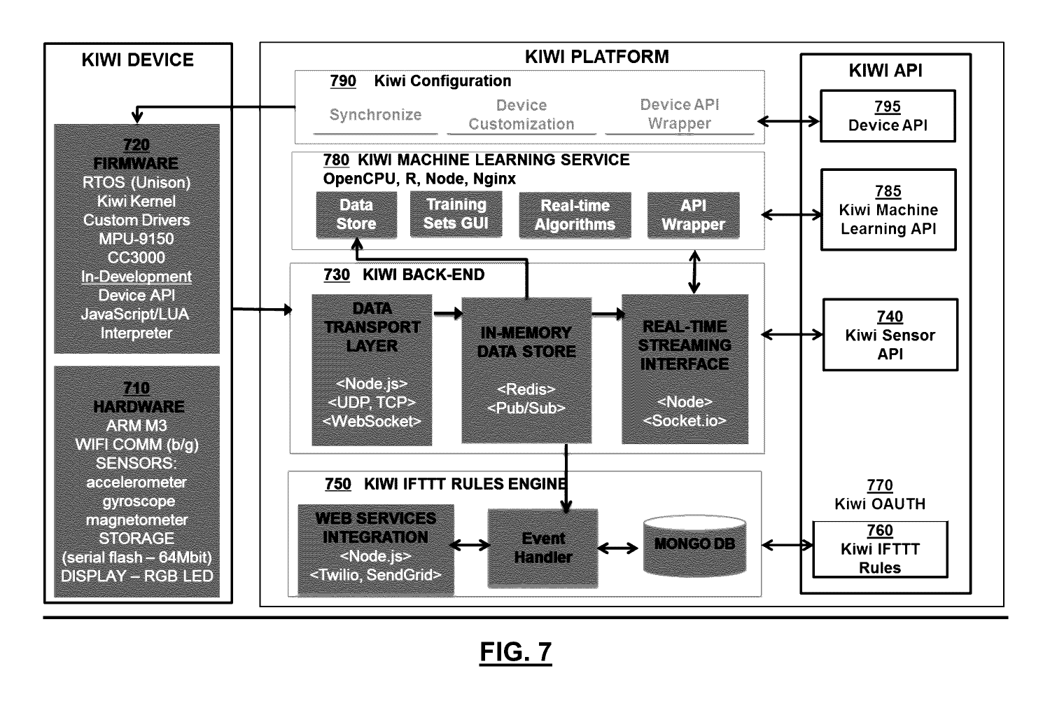

Referring now to FIG. 7, which illustrates an exemplary high level technology architecture for a wearable computing device in accordance with one aspect of the invention.

Hardware 710 can be a custom engineered, multi-sensor, network connected, 1″×2″ system on a chip, e.g.: a wearable computer in casing and coupled to or in the form of a strap.

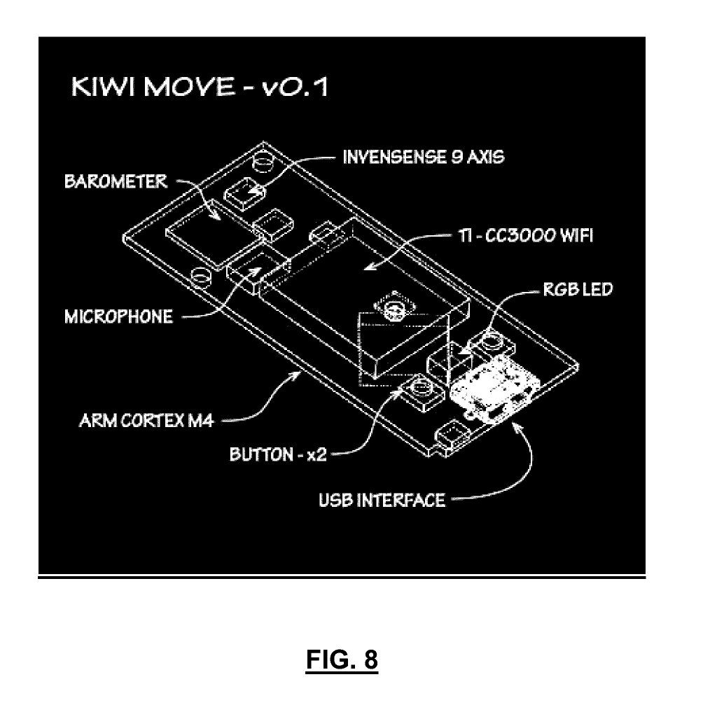

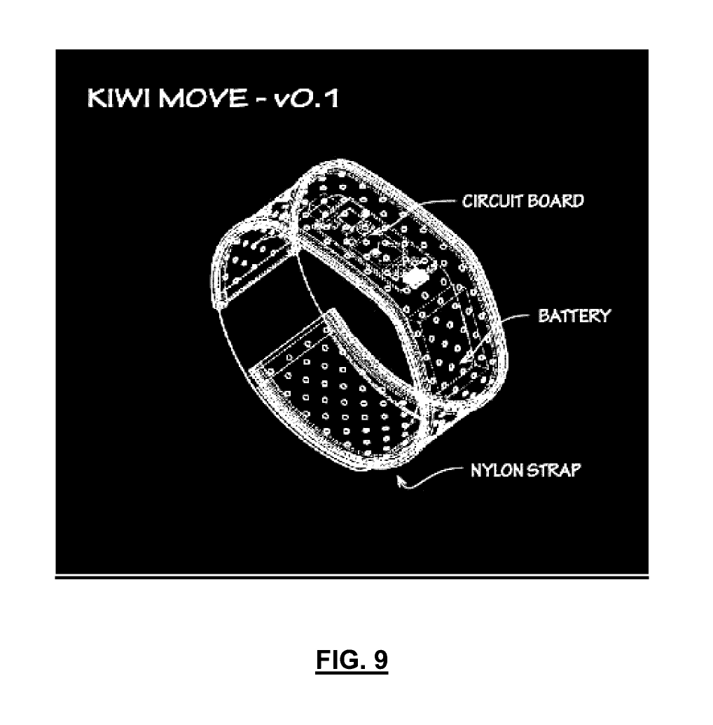

The schematics, shown at FIGS. 8 and 9, can be based on various designs such as open source design.

In addition, sensor data can be transmitted over a network (e.g. W-fi, 4G, Bluetooth and so on) to a Kiwi cloud platform; alternatively or at the same time, data can also be recorded to on-board storage medium.

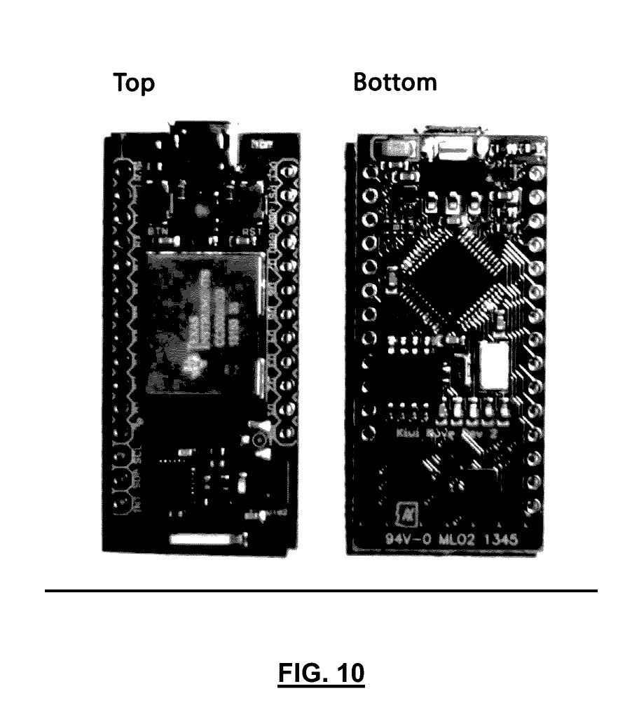

In one exemplary embodiment of the invention, such as illustrated in FIG. 10, the hardware component details can be the following:

| | | Alternative Options |
|---|---|---|
| | Examples | or Upgrades |
| Hardware | | |
| Processor | STM Cortex M3 ARM | STM Cortex M4 |
| | 128k-48 pin | |
| Sensors | InvenSense IMU | Microphone, Barometer, |
| | | Thermometer, Temperature |
| | | Sensor (STM) |
| On-Board Storage | Serial Flash 64 MB | |
| Communications | TI CC3300 Wi-Fi | |
| Battery | Li-Po 400 mA | |
| LEDs | 1xRGB, 1xBlue | |
| Connector | USB Micro B | |
| Utilities | Fuel Gauge | Power Management |
| Software | | |
| On-Board OS | Control Loop-C (IAR) | POSIX (Unison RTOS) |
| Utilities | File Management | File and Power Management |

Firmware or software 720 can be a robust, scalable and high-performance firmware, ensuring the device is fully programmable.

Real-time operating system can enable the device and system administrators to adapt quickly to market needs, and provide powerful features to developers. There may be an embedded system that integrates with the Kiwi back-end and API. The software system can be designed to be fully-programmable, built on a real-time operating system, with custom sensor drivers and API abstraction.

The embedded system can be built on top of a real-time operating system, which enables faster time to market for new sensor modules as well the capacity to provide a robust device API.

The application logic in the embedded system can be built to generate and transmit raw and calibrated sensor data and motion events. Optionally, the firmware may provide additional application logic, including better feedback, more control over transmission process, access to on-board storage and an upgrade to the Inertial Measurement Unit driver layer for improved quality and richness of sensor data.

The back-end component 730 can provide developers with simple web-based access to sensor data, using as few as five lines of code. The back-end 730 can handle a lot of the processing weight to translate device messages into meaningful and structured data that inform application design and development.

For example, the back-end component 730 can receive and process device information, sensor data stream and motion events, making this available in real-time for application development and algorithm design.

The back-end component 730 can also integrate with workers (e.g. machine learning service, rules engine, device configuration) and provide simplified access to core back-end and integrated services through a hybrid streaming and rest API.

Conversion from hexadecimal to binary form and calibration point for raw data can be performed on the back-end 730. For example, the UDP server can extend to TCP layer. A transport reliance layer may also be available to ensure data reliance.

In one example embodiment, Redis can be used as in-memory data store and middleware that provides pub/sub functionality for sensor data. Data can be further persisted to MongoDB.

Kiwi Sensor API 740 can be an simplified API call for raw streaming data and event call, allowing for integration into applications with as few as five lines of code. For example, Kiwi Sensor API 740 may be a hybrid streaming and rest API that gives access to sensor data via a socket interface. The sensors provided may include, for example, accelerometer, gyroscope, motion events, magnetometer, sensor fusion, and so on. Data messages can be JSON based object(s).

Kiwi Sensor API 740 may be enabled by a server-side Node Kiwi back-end application that connects devices to Kiwi powered applications.

Kiwi Rules Engine 750 can be designed to encourage natural language processing and training of Kiwi Move for users. It can further enable programmability of the Kiwi Move by early users, adopters, technologists and citizens without requiring programming skills on the part of the users, adopters, technologists and citizens.

In one example, the rules engine 750 can include node based server side application that compares incoming motion events from devices, against rules stored in a database. Rules may be created, modified, deleted, or otherwise edited by users, system administrators or developers. For example, rules can be permutations of conditions (e.g. “if”) and actions (e.g. “then”). Rules engine applications can provide event handling functionality, and serve as a hub between device events and 3rd party offerings. Business logic and integration with 3rd party web services can allow for device events to be translated into actionable items.

In one example embodiment, the rules engine 750 can integrate with at least one of: SendGrid, Twilio; IFTTT, smart TV's, home automation and so on.

The Kiwi IFTTT Rules API 760 can help developers to utilized standard REST API for motion events into 3rd party service offerings. The Kiwi IFTTT Rules API can provide the capacity for developers to build applications that leverage the IFTTT event handling engine. The API 760 can process or abstract away the complexity of underlying data structures, which are stored in MongoDB.

The Kiwi OAUTH API 770 can be designed to facilitate application development, to ensure personal ownership and verification of devices. For example, the Kiwi OAUTH API 770 can allows for standard user signup, registration, authentication and activation. The Kiwi OAUTH API 770 can add a security layer to ensure proper validation of device and user. In addition, the API 770 can include permissions structure for enabling users to connect to various developer applications.

The Kiwi Machine Learning Service 780 can allow for users, system administrators, developers and scientists to place their algorithms on a storage system (e.g. a cloud system) to be utilized by consumers through devices. The scalable and robust machine learning platform helps accelerate advanced application development.

For example, Kiwi Machine Learning Service 780 can run on OpenCPU, with elastic computing managed using Node with Nginx. In another example, the platform can implement classifiers in R on Open CPU; Random Forests, Support Vector Machine and Neural Network with reference to training set CSV files. In yet another example, the platform can provide a GUI and API wrapper to record training sets, and run algorithms on streaming data using a simple socket interface. The platform can further support derived metrics for improving prediction results.

The Kiwi Machine Learning API 785 can extend platform offering from raw data and simple classification, to more advanced classifiers. For example, it can be implemented for simplified pattern matching recognition. In another example, the back-end platform 730 can be integrated with machine learning through wrapper API 785.

The Kiwi Configuration 790 can allow developers to program and control the device through a web client and API. It can also enable the Kiwi platform to position itself as a fully programmable open platform for wearable computing. Kiwi Configuration 790 can enable the developers and users to configure the Kiwi sensors and connectivity based on their personal preferences.

In one example embodiment, Kiwi Configuration 790 has features including the capacity to enable/disable sensors, set sample rate, toggle LED, set battery limitations, and manage connections.

Kiwi Configuration 790 can be designed to provide a synchronization service with devices, to support dynamic changes to device configuration, specifically a) control of user feedback systems based on real time events, and b) the ability to translate and push custom algorithms to (written in JavaScript and R classifiers) into Lua container for device level implementations.

The Kiwi Device API 795 can enable open platform for application development and full control to developers over wearable computer and embedded system without getting into low-level code. The API 795 can enable developers to programmatically set up device configurations based on application requirements.

The API 795 can further enable simplified REST-like interface to control all hardware components on the board as well as specific features for individual sensor modules.

### Data Transaction Volume

According to one embodiment of the invention, the transaction volume may be as follows:

The primary driver of transaction volume is the number of devices streaming sensor data to the Kiwi platform.

Current baseline estimate for a single-device streaming data for 2 hours at 40 Hz is a approximately 31,218 kb.

Transaction data can include accelerometer, gyroscope, device ID and timestamp. Additional sensor data (magnetometer, sensor fusion, temperature, audio and barometer) and custom sensor events (taps, orientations, free-fall, no motion) may also be included. In addition, device data such as battery status, configuration mode and other custom events can impact the growth of transaction volumes.

### Key Transactions

According to one embodiment of the invention, the key transactions may be as follows:

Device activation is a the first key transaction in the value-chain; this includes initialization in the Kiwi device register, followed by activation by user/developer on the Kiwi platform.

Device connection and streaming of live data is the next significant transaction; this occurs each time a Kiwi powered application is connecting through the Kiwi socket interface to package, process and classify sensor data.

The device is configured to send specific motion events (such as taps), which are recorded as significant transactions, if there is an associated rule for the specific device and motion event. The rules engine handler records this event and the corresponding action as a key transaction.

The association of Kiwi device's to Kiwi powered applications (structured as permissions) as well as the usage of various Kiwi powered applications are a key transactions in the value chain.

### Transaction Lifecycle

According to one embodiment of the invention, the transaction lifecycle may be as follows:

Device Initialize→Device Activate→Device Streaming→Rule Triggered

Device Activate→Permission Granted→Application Used

According to one embodiment of the invention, the system may depend on cloud infrastructure providers (Rackspace, Heroku, Amazon), web development frameworks (Express, Node, Redis, Socket) and/or web service providers (Github, Bitbucket).

### Data Collected

According to one embodiment of the invention, body vital data are collected using wearable sensor technology. For example, motion data may be collected. In addition, body vital data using micro electro-mechanical sensors (MEMS) may be collected as well. For example, the following data may be collected:
Inertial Measurement Unit
   Accelerometer (linear acceleration, g-force)
   Gyroscope (angular velocity, rotation)
   Magnetometer (directional orientation, compass)
   Sensor fusion (quaternion)
   Motion events (free-fall, no motion, motion thresholds, gestures)
Microphone
Ambient Temperature
Barometer
Perspiration sensor
Heart rate using ECG sensor
Power Status
Connectivity Status
Configuration Mode
Custom Parameters
Firmware Event Logs

### Data Acquisition

According to one embodiment of the invention, data acquisition is performed at the device layer. In another embodiment of the invention, Invensense is used as a sensor technology provider for inertial measurement unit.

The system firmware on top of a real-time operating system can lead to a robust embedded system, with custom drivers and self-calibration routines implemented.

According to one embodiment of the invention, data can be transmitted over Bluetooth, and/or cellular (e.g. 3G/4G/LTE) networks; using UDP/TCP, and/or a embedded WebSocket client and a machine-to-machine data transport resiliency layer.

Data transformation can be performed at the platform layer, this can include:
Data conversion (Hex to Decimal)
Motion metric computation, quaternion derivation, sensor fusion and multithread buffering
Motion Classification, device level interrupts for events including, tap detection, sudden gyration of accelerometer is single axis direction, free fall detection, no motion, shake.

### Data Enrichment

According to one embodiment of the invention, the first step on the server is data conversion from Hex to Decimal. The server also implements structured logic to handle different types of input (i.e. raw accelerometer, gyroscope, sensor fusion, tap's, custom motion events, self-test, device info). Sensor data is published to Redis server, with Socket clients subscribing, authenticated by device ID and token.

According to another embodiment of the invention, motion events (free-fall, zero motion, motion threshold, taps, orientations, gestures) are recorded and stored in MongoDB and are made available through a Kiwi IFTTT Rules API as event logs.

Real-time integration through a socket interface with the Kiwi machine learning platform accelerates development of advanced applications.

Calculation of Computed metrics (velocity, averages, speed, distance, variances) can be made available through Kiwi Sensor API. Storage of training data sets for motion signatures are also possible.

### Usage by Developers

According to one embodiment of the invention, developer kits can include the device and strap plus access to the Kiwi development platform and sample code repository.

With three simple steps and a matter of minutes, developers can set up their alpha Kiwi units to stream and analyze sensor data:
Step 1: Power Up
Step 2: Connect to Wi-Fi or any other kind of network
Step 3: Activate the Kiwi device
Step 4: Stream data to Kiwi cloud and test sensors

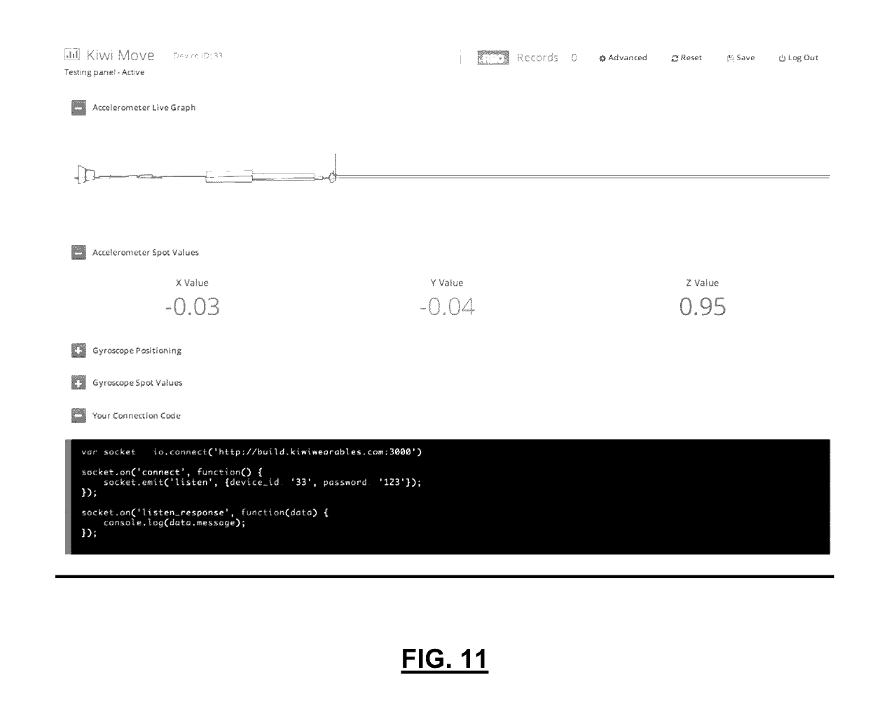

A user interface (see FIG. 11) can be provided to make it easy for developers to analyze the sensor data, as well as quickly record training sets and run real-time prediction and classification algorithms. The UI can enable developers to:
Visualize sensor data
Record raw data in CSV files for analysis
Visualize motion event data (i.e. Tap events, Rotation events)

The feature set of the Kiwi developer tool kit can further include:
Drag and drop training sets into machine learning platform
User interface with drop down to select from machine learning and other classification algorithms

The Kiwi Sensor API 740 makes it easy for developers to connect the Kiwi real-time streaming sensor data and motion event to start building mobile and web user experiences.

The following snippet illustrates the simplicity with which developers can get access to the sensor data:

var socket = io.connect(‘http://build.kiwiwearables.com:3000’)
socket.on(‘connect’, function( ) {

socket.emit(‘listen’, {device_id: ‘31’, password: ‘123’});

});
socket.on(‘listen_response’, function(data) {

console.log(data.message);

});

### Motion Classification

According to one embodiment of the invention, the Kiwi platform is integrated through a socket interface and wrapper API to a machine learning platform, running two algorithms (1) Support Vector Machine (2) Random Forest.

Applications may use the API to save motion sensor data to a data store, and run prediction algorithms in real-time. These applications are focused on daily human activity classification (i.e. sitting, standing, sleeping, walking, running, biking), which can be part of the Machine Learning API.

In addition, Kiwi has developed easy to use algorithms for simple and basic motion classification. These algorithms can be written in JavaScript and provide a good starting point for developers to optimize or extend this code base (made available as sample applications on github). For example, two algorithms (1) Euclidean Distance (2) Dynamic Time Warping may be implemented and tested in two use cases (1) Detecting smoking gesture with hand; (2) Detecting a soccer players kick.

Sample API wrapper calls may include:
Socket.emit (“save motion data”)
Socket.emit (“run random forest algorithm”)
Socket.listen (“algorithm result”)

### Sample Applications of Kiwi Technology

According to various embodiments of the invention, the following applications may be possible with the Kiwi system. These applications are for illustrative purpose only and in no way meant to be limiting or restricting in this patent application:

Application 1: Kiwi if-this-then-that

Mobile interface for users to activate Kiwi, set up rules (i.e. which conditions to detect and what actions this should trigger).

Conditions are a range of motion events, including Taps, No Motion, and Motion Start.

Actions include sending email/SMS/Tweet as well as ability to track and log the event.

### Application 2: Punching Game

A web-based game that measures punch strengths and manages a leaderboard.

Game uses custom classification of Shake gesture and Punch Stream.

Application 3: Data Visualization with Processing.js

Created a human computer interaction and motion tracing application that connects Kiwi sensor data (accelerometer and gyroscope) to Processing.js.

### Application 4: Home Automation

Used motion events (tap and orientation change) to control an Arduino connected light switch.

This application is being extended to support a wide range of connected home appliances, including lights, blinds and smart TV's.

### Application 5: Basketball Form Improvement

The application compares sports motion signatures in real-time; currently testing and optimizing for free throw and jump shot event data to recorded training sets for motion signatures to help improve physical form consistency.

The Kiwi team has extended this to Soccer kicks, using a dynamic time warping algorithm.

### Application 6: Smoking Cessation App

Working in collaboration with health care technology professionals, implemented an algorithm to detect the hand motion of smoking a cigarette.

Developed an engaging user experience that meshes wearable tech with changing behavior through social integration and gamification.

### Data Storage for Long-Term Analytics

Training data sets may be created, modified and/or stored for specific motions, to support current application development. Examples may include:

Smoking, drinking, eating (upper arm motion events)

Soccer kicks (lower leg/ankle actions)

Symbols and Alphabets (writing arm, full simulation motion)

In addition, optimal motion signatures may be created, modified and/or stored to support development of applications for improving motion form. Examples may include:

Good free throw and jump shot

Optimal golf swing

Optimal swimming stroke

Optimal biking cadence

### Kiwi Application

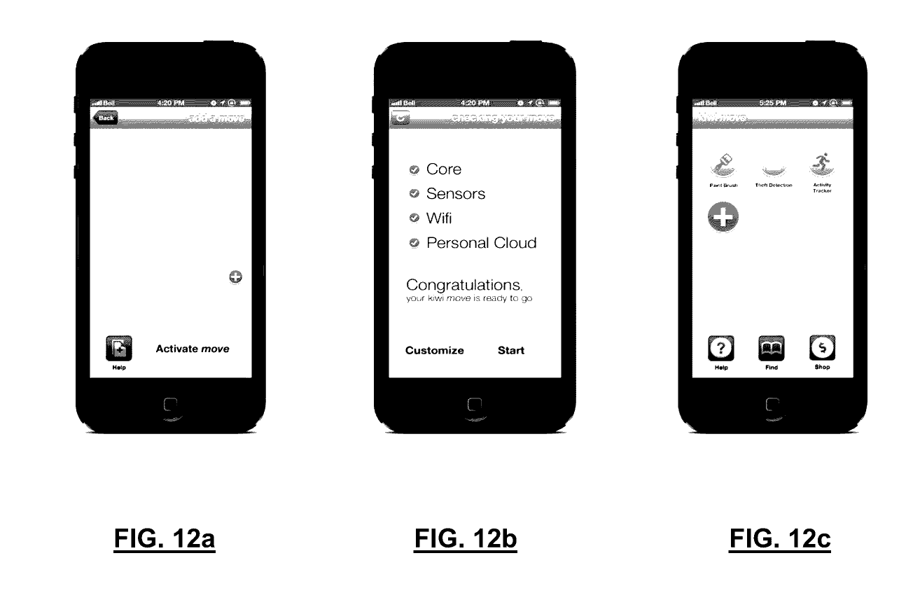

The Kiwi App can guide new users through the activation process, and how to use their Kiwi device with the Kiwi flagship apps as well as other developer applications. FIGS. 12a-12c each illustrates an exemplary mobile application for a wearable computing device in accordance with one aspect of the invention.

### Analytic Products

The Kiwi platform can provide a developer tool kit, which can be a primary analytic tool. This tool can include a Kiwi device dashboard, with each Kiwi configuration and status, as well as a graph visualization of raw sensor data.

Additional features of the developer tool kit include:
The ability to record raw data in CSV format
The ability to drag and drop training data sets
3D gyro visualization
Motion tracing
Data buffering
Drop down classification algorithm
User interface for real-time prediction using machine learning

Based on our research, access to raw data and a simple to use interface for machine learning are unique to the Kiwi tool kit. Furthermore, the Kiwi platform comes with complete access to the code base for sample applications. Most companies either provide an SDK or an API; based on our research and experiences, the SDK's are generally difficult to set up and complex to work with, while some of the larger wearable tech.

Analytic models can represent specific motion events and optimal motion signatures; these include the hand motion of smoking a cigarette, the foot motion associated with various soccer kicks and the arm motion associated with a basketball free throw.

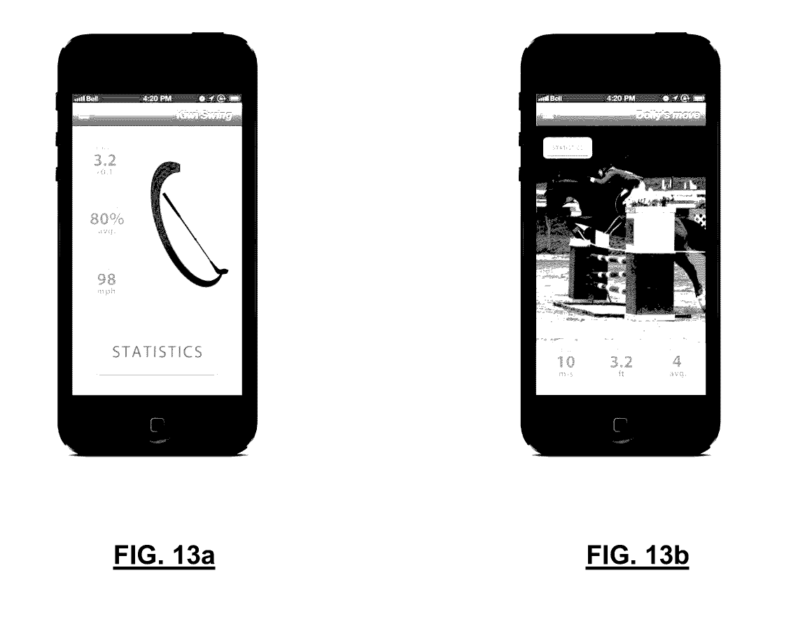

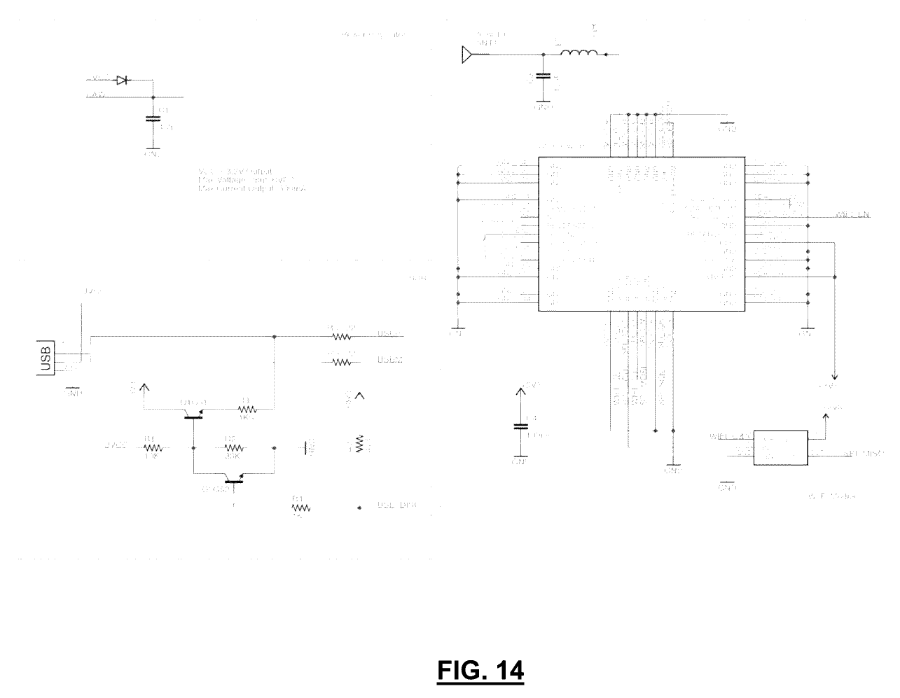

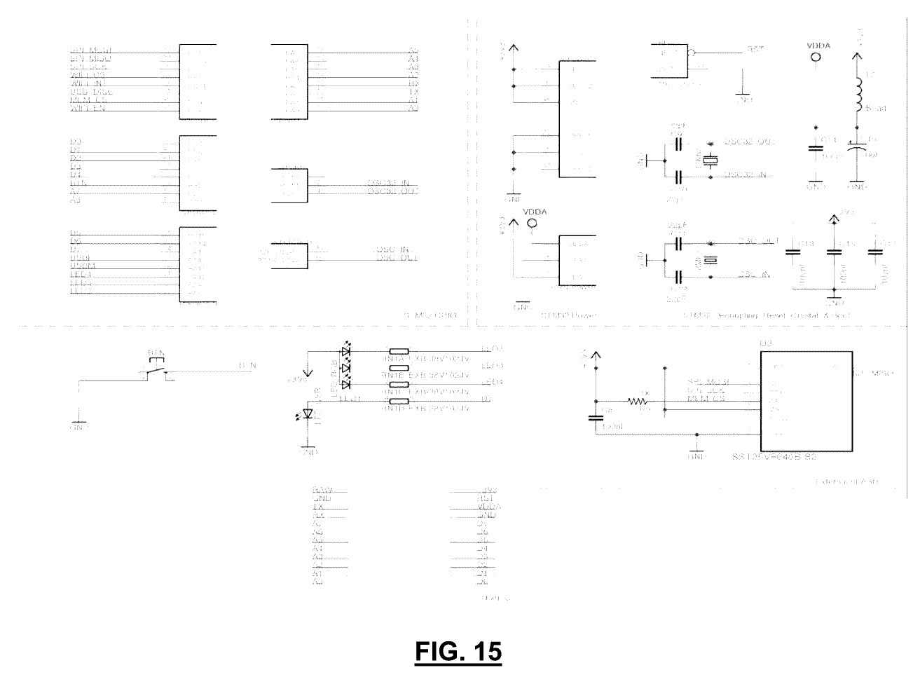

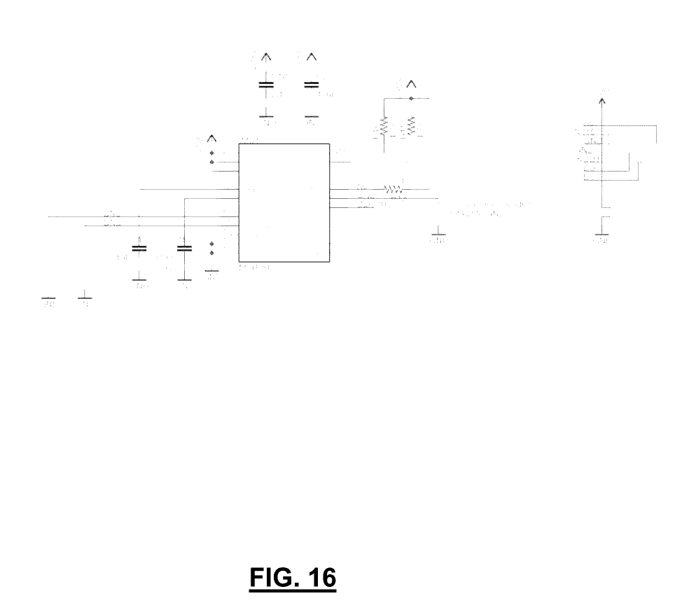

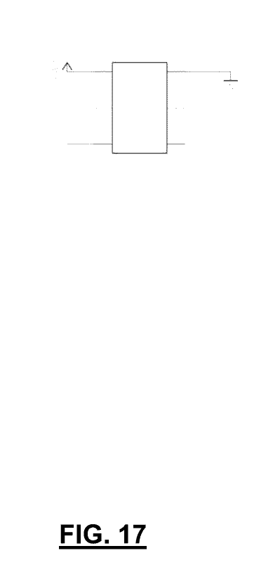

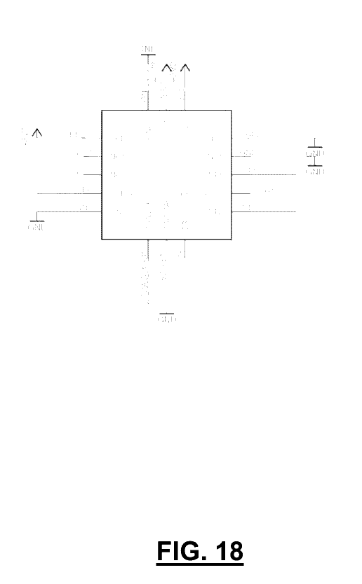

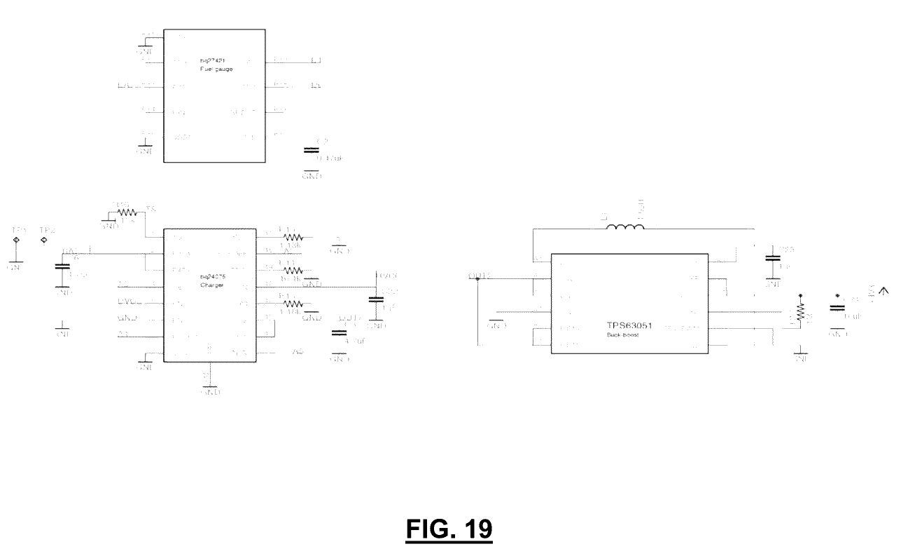

Referring now to FIGS. 13a and 13b, each illustrating an exemplary mobile application for a wearable computing device in accordance with another aspect of the invention.

In one embodiment, the collected data conceptualizes body vital information acquired from MEMS:
Linear Acceleration and G-force
Angular Velocity and Rotation
Magnetic resistance
Ambient temperature
Localization AHRS
(Attitude Head Referencing System)
Weather prediction
Personal Environment Contextualization

Following results may be inferred from each data collected, the list is illustrative only and not meant to be limiting:
Motion signatures
Gesture classifications:
Smoking, drinking, eating,
Computed metrics: speed,
degrees of rotation air time
Visualization: overlay mappings

### Exemplary Features of “KIWI MOVE” Technology

The Kiwi Move includes several innovative features which are not available in devices currently available on the consumer market. These features can include:

It can receive deliberate/active inputs (i.e. taps/gestures/learned & recognized motions) and passive inputs (i.e. environmental conditions) via a multiplicity of sensors including, but not limited to an: accelerometer, a gyroscope, a magnetometer, an barometer, a microphone and a temperature sensor.

It can save data from the sensors to on-board storage. Storage media include, but are not limited to:

EEPROM memory;

NAND serial flash; and/or

MicroSD embedded and with removable case.

The structure of the sensor data is listed below. It can be expanded or contracted according to the specific computing task performed:

| | | | | | | |
|---|---|---|---|---|---|---|
| | Time- | | Sensor- | | Sensor- | |
| DevID | Stamp | DataLen | Data 1 | . . . | Data n | CRC16 |

| | | | |
|---|---|---|---|
| 2 bytes | 4 bytes | 2 bytes | 2 bytes |

DevID—device identification number.

TimeStamp—packet generation time: milliseconds from device start or reset.

DataLen—length of encapsulated data in packet

SensorData—data from various sensors—variable length, depending from amount of sensors date included.

CRC16—CRC sum for all packet's bytes (header+data)

Sensor Data packets can contain the following fields:

| | |
|---|---|
| DataType | Sensor data |

1 byte

DataType—type of sensor data:
Accelerometer: Type=0
Gyroscope: Type=1
Magnetometer/Compass: Type=7

and so on. Each sensor is assigned unique datatype identifier.

Sensor data: the following is a example subset of possible sensor data types:

accelerometer, gyroscope, magnetometer, quaternion, barometer, temperature, step counter (steps, walk time), orientation, elevation.

Computed data—for each specific motion captured event specific data metrics are calculated and stored.

It can perform and process motion tracking tasks without being connected to the internet or other types of network. In addition, there exist certain advantages to processing information on the device side (e.g. on-board processing), as applications may include iterative rules that leverage data from different sensors to perform tasks such as activity tracking. This avoids a high volume of data being pushed to the cloud in order to perform processing.

According to one embodiment of the invention, an example motion capture event may be as follows:

A short motion that occurs at the gym is a bicep curl. This motion, when sensed by the device, is captured and stored locally to the device for comparison with a given profile. This can be a unique profile, catered to the individual, or a general “bicep curl motion” data set. When the motion is detected, values are captured for analysis and transmission. Possible analytical measures include, but are not limited to:
Bicep curl
Time Duration
Off-axis drift
Variance, standard deviation, max, min and average accelerometer x, accelerometer y, accelerometer z
Variance. standard deviation, max, min and average gyroscope x, gyroscope y, gyroscope z
Variance. standard deviation, max, min and average magnetometer x, magnetometer y, magnetometer z
Variance. standard deviation, max, min and average barometer
Covariance:
   Accelerometer x, gyroscope x
   Accelerometer x, gyroscope y
   Accelerometer x, gyroscope z, all possible combinations of each access 30 points

For example: if it carries the logic for measuring motion gestures related to gym/fitness-related activities, it will work without needing access to the internet to record and classify motion data while the user is in the gym.

Furthermore, the device can relate to, be configured by and trigger actions when it senses its arrival at and leaving of locations; whereas the user enters a particular location, the device can activate a specific mode that would be used in that location.

For another example: If a user downloads the “Gym” Activity classification profile from an online platform (or from local storage on their home computer). This activity classification profile can then be triggered when the device locates itself to the gym.

This activity classification profile could be in the form of an application which recognizes specific motions which are commonly used in a gym environment. These motions would differ from those employed on, for instance, a soccer field.

In addition, specific applications may be trigged as well by the system: (a) device is configured to collect information such as location, time, data geo-fencing, user profiles, and so on, (b) the information is used by the processing system to determine a “state”, (c) the state is mapped to a combination of rules that may involve invoking one or more applications or application features, and (d) the application or application features are then executed in order to provide real time, adaptive on board sensor data processing.

For example: If a user arrives at a specific location, the device could trigger the loading of a location-contextual application, triggering the accessing of stored or networked activity classification profiles/algorithms, and activate specific sets and configurations for passive/active sensor inputs.

For another example, as a user enters an office, the device discover the location's network. This network could either be online or offline, secured or unsecured, as long as it's able to provide geo-locational reference information. Once the device has recognized its location it could then load a specific profile to customize the device's behaviour, contextualized to that location. Two examples below further illustrate the functions and features above:

1) Jeremy Enters his Workplace:

The device recognizes that it is in the presence of Jeremy's Office wifi SSID

The device then customizes its behavior so as to load a posture tracking application, loads locally stored sitting and standing activity classification profiles and begins to recognize sitting and standing motions.

It stores these sensed events to local storage.

Given certain activity/motion event thresholds it is then customized to send a notification to Jeremy's mobile phone to let him know that he's been sitting for an extended period of time.

It does this by accessing on-board storage to provide a reference set of data to be classified against and compared with.

2) Tina Enters her School:

The device recognizes that she is at school as it is able to discover the School's wifi SSID and localizes her there.

It loads a stored “school” location which triggers the loading of a note-taking application on her tablet, a specific double-tap gesture which enables the device's recording and storing functions to save audio notes from her classroom instruction. The device then routes an instruction to the internet which sends a email and SMS notification to her parents to let them know that Tina has arrived safely to school.

In addition, the system and device can connect, send and receive instructions via multiple connectivity/transmission protocols to/from other networked/connected devices, platforms and applications.

For example: online/internet platforms, user's home network, connected devices (e.g. fridge or A/C), mobile telephony devices such as phones, other wearable devices etc.

Furthermore, the device can be designed for long-term usage. Some technology enables significant on-board storage and processing, at the expense of battery life. Therefore a significant increase in the device's uptime can be realized by transferring processing intensive tasks to networked processing devices (such as cloud-based server infrastructures). Many of these tasks can also be performed on the device. Examples of these tasks include, but are not limited to:
Data and information processing and sensor data fusion; and
Algorithmic sensor data classification; and
Accessing cloud-based internet services such as Twitter/SMS/Shazam.

The device and system can further leverage connectivity and on-device storage to act as a connectable storage device. For example, it may be used as a W-Fi portable hard drive.

### Environment for Implementing the Kiwi Technology

The device can run on a computing system which includes, but is not limited to, components such as:
a microprocessor
data storage
a real-time operating system which includes but is not limited to
   A File Allocation Table File System
   NAND/NOR File System
Connectivity components such as: Telnet, Posh—POSIX shell Tftpd, thttpd, NAT & PAT, SLIP and PPP, DHCPServer, Power On Self Test (POST)

Example activities of the processing system include, but are not limited to:
Receiving input and/or sensed information; and/or
Modifying the state of the device; and/or
Triggering events; and/or
Performing processing, combining and routing of sensor data; and/or
Recording and storing sensor data;

The Operating System on the device is designed to facilitate on-device application development, processing and storage of data for development purposes. This operating system also communicates seamlessly with a cloud-based development environment, enabling and facilitating on and/or off-device application development. As described below, at least five layers are provided in the operating system.

The combined development environment gives programmers access to standard programming practices available for desktop computer development:
Hardware Interrupt and Drivers for base analog and digital data conversion
Nanoexec: pthreads, semaphores, mutexes, condition variables, message queues, join, barriers, memory managers, timers, clock, rendezvous, events, interrupt management. directory or name server capabilities
Services layer for processing between hardware components
Library layer: mathematical operations used in data analysis, data transmission protocol library, interface protocol library
I/O servers: Communication protocol (TCP/IP, Bluetooth, Zigbee, GPRS), Storage FAT32, NAND, HID

There may be an Application Container that rests above the five below layers and can have sub applications held within for various processing sequences.

The device is innovative in several aspects, some of which are highlighted below:

1. can run multiple applications separately on a single device. (ie. Motion tracing or sound recording);

2. can run multiple applications concurrently e.g. motion tracing and sound recording on a single unified device;

3. the device can be worn on multiple parts of the body, and used in tandem with other wearable devices;

4. the device can be concealed within clothing garments by using a collar stem or other unique clips;

5. process and leverage multiple sensor data streams concurrently. For example, concurrent processing of sensor data streams is possible by using for example a unified sensor data format which streamlines multi sensor processing, for example:
a. Audio, accelerometer, gyroscope, magnetometer, barometer and temperature:
   i. Audio continuous streaming
   ii. Interrupt of event sending of sensor payload from Section 1.1 as event is detected

6. retrieve, store and employ device behaviour profiles for contextualization and customization; and

7. contains the following interfaces/structures for application development:
a. Native applications which reference on-board data storage and/or networked data;
b. Third-party applications which reference on-board storage and/or networked data; and
c. Classification Algorithms which leverage on-board processing to perform sensor data classification:
   i. Dynamic Time Warping
   ii. Random Forests Algorithm
   iii. k-NN (k-nearest neighbor),
   iv. Fuzzy k-NN (Fuzzy k-nearest neighbor),
   v. SVM (support vector machine),
   vi. LS-SVM (least square-support vector machine),
   vii. PSVM (proximal support vector machine),
   viii. and ELM (extreme learning machine); and
d. Device Behaviour Profile containers (can be customized for a specific wearer, location, time, activity, and so on.)

According to one embodiment of the invention, the following technical capabilities are provided by the device and the system:

1. The System Contains the Following Interfaces/Structures for Application Development:

a. Read/Write Access to on-device storage for the purpose of creating, and implementing applications.

b. Native applications which reference on-board data storage and/or networked data;

and

c. Third-party applications which reference on-board storage and/or networked data;

and

d. Classification Algorithms which leverage on-board processing to perform sensor data classification.

e. Device Behaviour Profile containers which can be created and customized for a specific wearer, location, time, activity. and so on. This enables user driven creation and customization of training tools, for example:
i. a Cloud based real-time training tool where by the user is prompted to preform specific data classification tasks and place the device in a specific orientation and location on the body.
ii. A Smart-Phone based real-time training tool
iii. A profile is developed based on these tasks and transferred to be stored locally on the device for the specific application

A weight training scenario example at the gym is as follows: a user is prompted to preform three push ups, two jumping jacks and five bicep curls; these motions are classified and attributed to a custom profile for the individual for their gym application; and the profile is stored locally to the device as well as in a cloud and smartphone application which is referenced upon enabling the gym application.

f. Access to on-device memory structures to buffer data streams, save data to temporary storage or pre-load applications.

g. Access to pre-defined device orientation profiles to enable an application to be calibrated.

2. Given an Active Device Profile:

a. Ability to calibrate sensor data based on where the user wears the device

b. Run multiple classifiers on the sensor data set in real-time;

c. Connect to on-board storage or networked devices and perform further processing.

3. Given Deliberate or Passive User Input:

a. Ability to modify the state and behaviour of the device

b. Ability to store sensor data and perform processing

c. Ability to perform follow-on on-device or off-device actions. For example:
i. Off-Device: “when I tap the device, call a cab”
ii. On-Device: “when I tap the device, load my fitness profile.”

### Additional or Enhanced Features

Additional or enhanced features of the device and system may include multiple applications running simultaneously depending on a user's location via Wifi detection, multi sensor communication over wifi, bluetooth and on board storage, sensor device connected to platform for providing “if X and then Y” for motion events, gesture recognition on the device and on the web, and so on.

A unified sensor data messaging platform, which allows the platform to interoperate with many different types of sensors, including to process sensor data from multiple devices, including in real time, and thereby enabling applications that use data from multiple sensor devices.

key issue in wearable computing is addressing the need for personalization or specificity, the fact that biological signals vary from person to person, and similarly correct interpretation of biological signal data from person to person will also vary. Some technologies proposes solutions involve developing a profile, usually over time, for each individual to assist in the interpretation of biological signal data for the individual. Kiwi further develops tools that allow users quite easily to code their own profile. The Kiwi system platform can use such self-coded profiles in order to create a personal profile.

The system further can: (a) enable deployment of cross-sensor platform applications, and promotes rapid development of applications that use sensor data, leveraging a development community; and (b) provide a significant degree of personalization, and rapid development of useful applications, by providing the basis for leveraging open innovation in respect of wearable computing.

### Mobile Applications

The device can operate complimentarily with one or more users' smartphones or cellular phones to provide accurate sensor measurements calibrations as well as accurate indoor and outdoor localization.

Greater resolution can be realized by increasing the number of wearable devices and/or cellular phones to which this method is applied.

For example, each of the cellular devices can be connected to a specifically identified wireless router each wearable device, which is also connected to this same wireless router. Each of the connected appliances/devices which are to be controlled, (eg. devices like smart TVs, smart/connected appliances and thermostats) can also be connected to the same wireless network (hereafter referred to as “controlled devices”). An application onboard one of the wearable/smartphones/cellular devices can act as a “hub”, processing and calculation engine (hereafter referred to as the “master” device or component). Each of the wearable devices can act as “slave” devices to the master device. The master device and the controlling devices can communicate bi-directionally. All information, including but not limited to calculations, locations, user IDs, device IDs, and master/slave/controlled device identifying information can be saved to one or more of onboard or other connected networked storage devices.

In accordance with one embodiment of the invention, a method of using the wearable computing device may be:

Step 1: Calibration:

Bring all of the devices close to each other in proximity so as to enable their respective Received Signal Strength Indicator (RSSI) readings to be very close in reading;

All of the “slave” devices send their RSSI readings along with their device ID to the master device;

The master device performs calculations onboard to calibrate the relative differences in RSSI readings for each device;

The result of this calibration is that the master device recognizes its relative difference in distance from each of the slave devices as well as the wireless router;

Each of these calibrations and location information is stored to on-device memory onboard the master device;

If configured, the “Controlled Device” can send a set of actions which can be configured to control the device during this or later stages. These actions can then be mapped to specific “Master or Slave Device” directives (ie. Mapping the TV turning on to a gesture, a tap, or a voice command like “TV”).

Step 2: Controlled Device Recognition

The master device will be brought into close proximity to each of the controlled devices. This enables the master device to recognize each of the controlled devices' distances and locations from the wireless router.

During this step controlled device can be given names, or other identifying information which may or may not contain location identifying information. ie. Living room TV, Kitchen Lights, Fridge, Washer.

This, in essence, amounts to a ‘landmarking’ of the controlled devices' locations relative to the wireless router.

These “Controlled Device” locations are saved to onboard or networked storage.

Step 3: Performing Master/Slave localization

The slave or the master device initializes a process to perform localization.

It sends a message to each of the controlled devices and slave devices to have them report their relative positions from the WiFi router.

Each of the slave devices (which may but are not required to also communicate via Bluetooth or other RSSI-enabled wireless connectivity protocol) also report their relative distances to the master device.

Triangulation calculations based on overlapping multi-RSSI radii are performed on-board the Master device. The result of this calculation is a precise localization measure relative to the wifi/wireless router.

Step 4: Controlling and Receiving Information from “Controlled Devices”

Given that the expected relative location of the master, slave and controlled devices has been established by following the previous steps:
The Master or Slave devices will perform a specific action which initializes the process of recognizing the locations of the controlled devices.
The Master device then calculates the relative orientation and positioning of itself relative to the controlled devices.

The user or wearer performs a specific, defined gesture or issues a command which identifies the controlled device which is to be controlled.
i.e. The user could make a gesture in the direction of the TV or the user could say the words “Kitchen Lights” to turn them on or off.

For example, the magnetometer sensor, working in parallel with the localized device, would be able to directionally issue an instruction to a specific “Controlled Device.” A voice command could also enable a command to be sent to the appropriate controlled device.

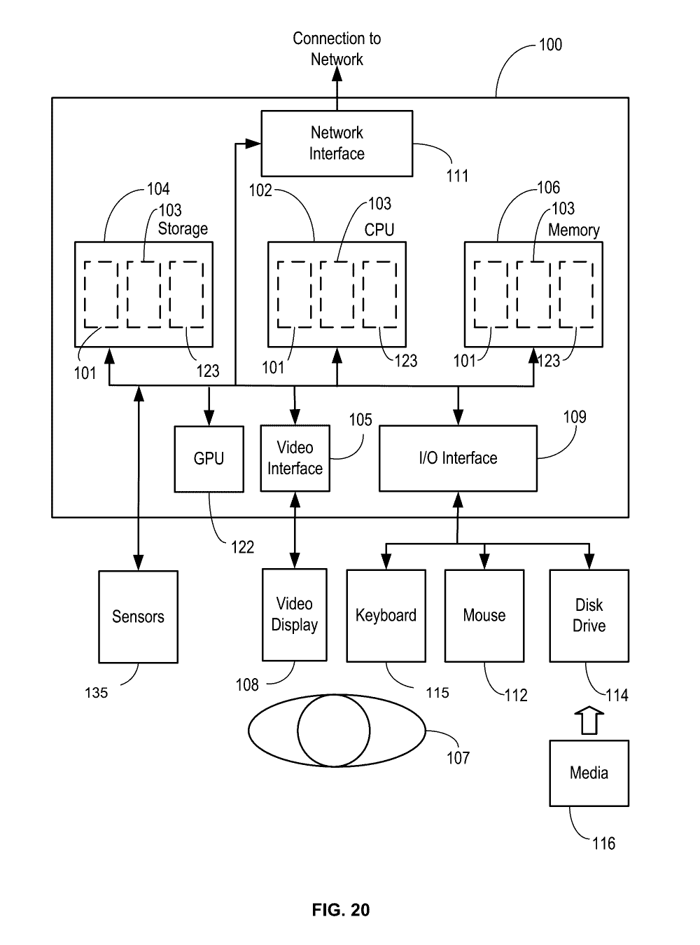

The present system and method may be practiced in various embodiments. A suitably configured computer device, and associated communications networks, devices, software and firmware may provide a platform for enabling one or more embodiments as described above. By way of example, FIG. 20 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any mobile platform, including the iOS™ platform, Android™, WINDOWS™ or BLACKBERRY™.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

What is claimed is:

1. A computer-implemented method comprising, at a network processor in communication with a server computer over a communication network: a) receiving input from a plurality of sensors and b) performing a motion tracking task based on a user profile.

2. The method of claim 1, further comprising storing at least one of a plurality of training data sets.

3. The method of claim 1, further comprising tracking at least one of a plurality of information comprising location, time, date or user profile.
